(19) United States
(12) Patent Application Publication
(10) Pub. No.: US 2014/0037100 A1
(43) Pub. Date: Feb. 6, 2014

(54) MULTI-MICROPHONE NOISE REDUCTION USING ENHANCED REFERENCE NOISE SIGNAL

(71) Applicant: QSound Labs, Inc., Calgary (CA)

(72) Inventor: David Giesbrecht, Toronto (CA)

(73) Assignee: QSound Labs, Inc., Calgary (CA)

(21) Appl. No.: 13/959,695

(22) Filed: Aug. 5, 2013

Related U.S. Application Data
(60) Provisional application No. 61/679,679, filed on Aug. 3, 2012.

(51) Int. Cl. G10K 11/00

(52) U.S. Cl. CPC G10K 11/002
USPC 381/71.8

(57) ABSTRACT

Systems and methods of improved noise reduction include the steps of: receiving an audio signal from two or more acoustic sensors; applying a beamformer to employ a first noise cancellation algorithm; applying a noise reduction post-filter module to the audio signal including: estimating a current noise spectrum of the received audio signal after the application of the first noise cancellation algorithm, wherein the current noise spectrum is estimated using the audio signal received by the second acoustic sensor; determining a punished noise spectrum using the time-average level difference between the audio signal received by the first acoustic sensor and the current noise spectrum; determining a final noise estimate by subtracting the punished noise spectrum from the current noise spectrum; and applying a second noise reduction algorithm to the audio signal received by the first acoustic sensor using the final noise estimate; and outputting an audio stream with reduced background noise.

### CROSS-REFERENCE TO RELATED APPLICATIONS

This application incorporates by reference and claims priority to U.S. Provisional Application No. 61/679,679, filed on Aug. 3, 2012.

### BACKGROUND OF THE INVENTION

The present subject matter provides an audio system including two or more acoustic sensors, a beamformer, an optional acoustic echo canceller, and a noise reduction post-filter to optimize the performance of noise reduction algorithms used to capture an audio source. The noise reduction algorithm uses an enhanced reference noise signal to improve its performance.

Many mobile devices and other speakerphone/handsfree communication systems, including smartphones, tablets, Bluetooth headsets, hand free car kits, etc., include two or more microphones or other acoustic sensors for capturing sounds for use in various applications. The overall signal-to-noise ratio of the multi-microphone signals is typically improved using beamforming algorithms for noise cancellation to ensure good quality communication for voice applications (e.g., telephone calls, voice recognition, VOIP). Generally speaking, beamformers use weighting and time-delay algorithms to combine the signals from the various microphones into a single signal. Beamformers can be fixed or adaptive algorithms.

An adaptive post-filter is typically applied to the combined signal after beamforming to further improve noise suppression and audio quality of the captured signal. The post-filter is often analogous to regular mono microphone noise suppression (i.e., uses Wiener Filtering or Spectral Subtraction), but it has the advantage over the mono microphone case in that the multi microphone post-filter can also use spatial information about the sound field for enhanced noise suppression.

For near-field situations, such as phone handset or headset applications, it is assumed that the target source (e.g., the user's voice) is located relatively close to the device's primary microphone and the noise or unwanted sources are located farther away from the microphones. In a typical example of a two-microphone configuration for a mobile phone being used in handset mode, a primary microphone located close to the user's mouth is used to capture the user's voice, whereas a secondary microphone (typically located on the other end of the phone by the user's ear) is used to capture a noise reference signal from various noise sources. The noise sources may be located anywhere around the user, but are assumed to be far from the device when compared to the microphone-to-microphone distance. As far-field signals, the unwanted noises are generally picked up to the same degree by each microphone. It is common to classify the microphone inputs as “primary input” and “noise reference” signals according to the following definitions:
a) Primary input x₁(t)—comprises one or more microphone signals that are located closest to the target source. These signals are dominated by both the target voice s(t) and background noise n(t).

x₁(t)≈s(t)+n(t)
b) Noise reference x₂(t)—comprises one or more microphone signals that are located farthest from the target source. These signals contain background noise (at a similar amplitude to the primary input x₁(t) because the noise sources are assumed to be in the microphone's array's far-field) and very little of the target voice signal.

x₂(t)≈n(t)

For this type of microphone-source geometry, it is common for the multi-microphone post-filter to simply use the noise reference single x₂(t) as the noise power estimate for updating Weiner Filter gains. The advantages of this type of approach are its simplicity (no explicit noise estimation algorithm is required), as well as its ability to track both stationary and non-stationary far-field noise sources.

The disadvantage is that x₂(t)≈n(t) is overly-simplistic: depending on the microphone separation and the distance to the target source there is often some leakage of the target voice into the noise reference signal. As such, a more accurate formulation of x₂(t) is as follows:

x₂(t)=as(t)+n(t)

α<1

where α represents a voice leakage factor.

In this equation, as α approaches 1 (e.g., for devices with narrower microphone separation and/or when the user's mouth moves further away from the primary microphone(s)) the reference noise signal becomes more corrupted with the target voice signal. This causes the noise reduction algorithm to suppress or distort the target voice.

In addition, any amplitude mismatch between the microphones, such as those due to manufacturing tolerances or acoustical characteristics of the room or device's form factor, can lead to inaccuracies in the system's noise estimate, i.e., the power of the noise signal n(t) will not be equivalent in the following two equations:

x₁(t)≈s(t)+n(t)

x₂(t)=as(t)+n(t)

Accordingly, there is a need for an efficient and effective system and method for improving the noise reduction performance of multi-microphone systems employed in mobile devices by offering improvements to these issues by correcting the noise reference signal to account for a device's microphone geometry, as well as automatically adjusting for microphone and acoustic mismatches in real-time, as described and claimed herein.

### SUMMARY OF THE INVENTION

In order to meet these needs and others, the present invention provides an audio system including two or more acoustic sensors, a beamformer, an optional acoustic echo canceller, and a noise reduction post-filter to optimize the performance of noise reduction algorithms used to capture an audio source in which the noise reduction algorithm uses an enhanced reference noise signal to improve its performance.

In one example, a noise reduction system includes an audio capturing system in which two or more acoustic sensors (e.g., microphones) are used. The audio device may be a mobile device and any other audio communication system, including smartphones, tablets, Bluetooth headsets, hand free car kits, etc. A noise reduction processor receives input from the multiple microphones and outputs a single audio stream with reduced background noise with minimal suppression or distortion of a target sound source (e.g., the user's voice).

In a primary example, the communications device (e.g. a smartphone being used in handset mode) includes a pair of microphones used to capture audio content. An audio processor receives the captured audio signals from the microphones. The audio processor employs a beamformer (fixed or adaptive), a noise reduction post-filter, and an optional acoustic echo canceller. Information from the beamformer module can be used to determine direction-of-arrival information about the audio content and then pass this information to the noise reduction post-filter to apply an appropriate amount of noise reduction to the beamformed microphone signal as needed. For ease of description, the beamformer, the noise reduction post-filter, and the acoustic echo canceller will be referred to as “modules,” though it is not meant to imply that they are necessarily separate structural elements. As will be recognized by those skilled in the art, the various modules may or may not be embodied in a single audio processor.

In the primary example, the beamformer module employs noise cancellation techniques by combining the multiple microphone inputs in either a fixed or adaptive manner (e.g., delay-sum beamformer, filter-sum beamformer, generalized side-lobe canceller). If needed, the acoustic echo canceller module can be used to remove any echo due to speaker-to-microphone feedback paths. The noise reduction post-filter module is then used to augment the beamformer and provide additional noise suppression. The function of the noise reduction post-filter module is described in further detail below.

The main steps of the noise reduction post-filter module can be labeled as: (1) mono noise estimate; (2) (optional) mismatch correction; (3) noise reference signal analysis; (4) final enhanced noise estimate; (5) noise reduction using enhanced noise estimate; and (6) (optional) update mismatch correction values. Summaries of each of these functions follow.

The mono noise estimate involves estimating the current noise spectrum of the mono input provided to the noise reduction post-filter module (i.e., the mono output after the beamformer module). Common techniques used for mono channel noise estimation, such as frequency-domain minimum statistics or other similar algorithms, that can accurately track stationary, or slowly-changing background noise, can be employed in this step.

The optional mismatch correction process can improve noise reduction performance in situations in which a microphone mismatch is expected. Through the mismatch correction process, the secondary microphone signal (i.e., the noise reference signal) is corrected for anytime there is an invariant or slowly changing amplitude mismatch in the system. Such a mismatch between microphone signals can arise due to manufacturing tolerances and/or an acoustical mismatch due to the device's form factor or room acoustics. The goal of this process is to correct the noise reference signal so that the time-averaged noise power is equal between the primary microphone signal and the noise reference signal. This correction can be done in the time-domain or frequency-domain. The frequency-domain has the advantage that the amplitude correction can be performed on a frequency-dependent basis as shown in the equation below:

R(f,t)=X₂(f,t)β(f)

where X₂ is the secondary microphone spectrum (i.e., the noise reference spectrum) at time t. β is the frequency dependent amplitude mismatch correction, and R is the corrected noise reference to be used in the noise reference signal analysis.

It may be desirable to restrict the adaptation of the mismatch correction factor β(f) to be within a given range β_{MIN}≦β≦β_{MAX} to improve system stability. In addition, for implementations involving both the mismatch correction β(f), as well as well as acoustic echo canceller, additional robustness can be achieved by disabling the adaptation of β(f) when the speaker channel is active (i.e., when the far-end signal is active).

The noise reduction post-filter module may correct for microphone mismatch by adapting the mismatch correction factor 13(f) in real-time. As mentioned above, the algorithm assumes that all noise sources are located in the far-field of the microphone array. Therefore, the goal of the mismatch correction is to ensure that the noise level is approximately equal between the primary microphone X₁(f) and noise reference microphone X₂(f) when far-field noise sources are dominant.

The mismatch correction factor β(f) is adapted based on the time-averaged amplitude ratio |X1(f)|/|X2(f)| as follows:

$$β ( f ) = ( 1 - τ ) β ( f ) + τ \frac{\vert {X}_{1} ( f ) \vert}{\vert {X}_{2} ( f ) \vert}$$

where τ represents the adaptation time constant. It is further contemplated that adaptation may also be done using a power ratio or dB difference. The adaptation of β(f) is controlled via a Voice Activity Detector (VAD) and is only performed when the target voice is inactive (i.e., during noise-only periods). Common VAD algorithms include signal-to-noise-ratio-based techniques and/or pitch detection techniques to determine when voice activity is present.

The noise reference signal analysis process uses the corrected noise reference signal from the optional mismatch correction module to improve the noise estimate from the mono noise estimate module so that the system can track both stationary and non-stationary noises. As described above, there are situations in which the noise reference spectrum R(f) will be corrupted by leakage of the target voice into the noise reference signal. In order to obtain a final, robust noise estimate for the system, the noise reference spectrum must account for this leakage.

The voice leakage problem may be mitigated by “punishing” the level of the noise reference spectrum R(f) depending on the time-average level difference between the primary microphone spectrum X₁(f) versus the noise reference as follows:

$${R}_{P} ( f , t ) = R ( f , t ) λ ( f )$$

$$λ \leq 1$$

$$λ ( f ) = ℱ ( \frac{〈 {X}_{1} ( f ) 〉}{〈 R ( f ) 〉} )$$

R_{P} is the noise reference spectrum after being adjusted by the punishment factor, λ.

The punishment factor may be expressed as a simple piece-wise linear function for λ, but other alternatives such as quadratic or cubic functions are also appropriate. The behavior of the punishment factor λ can explained as follows below.

For a given frequency band, if the level difference between primary microphone level X₁(f) and the noise reference R(f) approaches 0 dB (i.e., the primary and secondary microphone inputs have equal power), it is assumed that a far-field noise source is dominant. Therefore, no voice leakage is present on R(f) and the punishment factor λ=0 dB (no noise punishment).

If the ratio X1(f/R(f) approaches an intermediate value μ corresponding to the expected voice level difference between the primary and secondary microphones, then there is a high probability of the target voice—and thus voice leakage on the secondary microphone—being present. In this case, the punishment factor λ approaches a minimum value (i.e., noise reference R(f) is maximally punished). The expected voice level difference μ can be easily approximated for a given device through either empirical measurement using a Head-and-Torso Simulator (HATS), or using information about the microphone array geometry such as:

$$μ \approx 20 {log}_{10} ( \frac{m + d}{m} ) [ dB ]$$

where d is the microphone-to-microphone distance (for dual microphone examples) and m is the expected distance between the primary microphone and the user's mouth.

If the ratio X1(f)/R(f) rises significantly higher above μ (e.g., due to acoustic diffraction effects or if the user moves his or her mouth closer than expected to the primary microphone), the voice leakage in R(f) becomes less of an issue and so the punishment factor λ rises towards 0 dB again. In other words, if the voice level difference between X1(f) and R(f) is very high, then a small amount of leakage will not cause the noise reduction algorithm to significantly suppress or distort the target voice.

It should be noted that the exact shape of the punishment curve 2 can be tuned to obtain the desired amount of aggressiveness of the noise reduction post-filter for a given application.

Although the primary example provided herein includes a noise punishment factor λ(f)≦0 dB, it may be desirable to have λ>0 in some situations where more aggressive noise reduction is wanted. Doing so acts as an alternative to the so-called “over-subtraction” factor used in Wiener Filtering to improve the stability of noise reduction algorithms and reduce musical noise artifacts, etc.

Additionally, it may be desirable in some situations to use different punishment curves λ(f) for different frequency regions to allow the multi-microphone noise reduction post-filter to be more or less aggressive at different frequencies.

The final enhanced noise estimate is obtained by taking the maximum of the punished noise reference spectrum R_{P}(f) from the noise reference signal analysis against the mono noise estimate on a subband-by-subband basis. As a result, the final noise estimate is able to track both stationary noise sources as well as non-stationary noise sources that the original mono noise estimator may have missed.

The noise reduction using the enhanced noise estimate process uses the spectral noise estimate from the final enhanced noise estimate process described above to perform noise reduction on the audio signal. Common noise reduction techniques such as Wiener filtering or Spectral Subtraction can be used in this process. However, because the final enhanced noise estimate has been enhanced to include non-stationary noise sources, the amount of achievable noise reduction is superior to traditional mono noise reduction algorithms. The noise reduction results are further improved (as compared to traditional noise reference signal techniques) by reducing the amount voice leakage in the noise reference signal and by automatically adjusting for microphone mismatch, as described above.

In one example, an audio device includes: an audio processor and memory coupled to the audio processor, wherein the memory stores program instructions executable by the audio processor, wherein, in response to executing the program instructions, the audio processor is configured to: receive an audio signal from two or more acoustic sensors, including a first acoustic sensor and a second acoustic sensor; apply a beamformer module to employ a first noise cancellation algorithm; apply a noise reduction post-filter module to the audio signal, the application of which includes: estimating a current noise spectrum of the received audio signal after the application of the first noise cancellation algorithm, wherein the current noise spectrum is estimated using the audio signal received by the second acoustic sensor; determining a punished noise spectrum using the time-average level difference between the audio signal received by the first acoustic sensor and the current noise spectrum; determining a final noise estimate by subtracting the punished noise spectrum from the current noise spectrum; and applying a second noise reduction algorithm to the audio signal received by the first acoustic sensor using the final noise estimate; and output a single audio stream with reduced background noise.

In some embodiments, the audio processor is configured to correct for a mismatch between the first acoustic sensor and the second acoustic sensor. The mismatch correction may be based on a comparison of the time-averaged amplitude ratio of the audio signals received from the first acoustic sensor and the second acoustic sensor when voice activity is not present. The mismatch correction may be based on a correction factor that is restricted within a predefined range. The adaptation of the correction factor may occur in real-time.

The audio processor may be further configured to apply an acoustic echo canceller module to the audio signal to remove echo due to speaker-to-microphone feedback paths.

The first noise cancellation algorithm may be a fixed noise cancellation algorithm or an adaptive noise cancellation algorithm.

Determining a punished noise spectrum using the time-average level difference between the audio signal received by the first acoustic sensor and the current noise spectrum may include determining a punishment factor curve. The punishment factor curve may be expressed as a linear or non-linear function and may include separate punishments factors within different frequency regions.

The second noise reduction algorithm may be a Wiener filter or a spectral subtraction filter.

In another example, a computer implemented method of reducing noise in an audio signal captured in an audio device includes the steps of: receiving an audio signal from two or more acoustic sensors, including a first acoustic sensor and a second acoustic sensor; applying a beamformer module to employ a first noise cancellation algorithm; applying a noise reduction post-filter module to the audio signal, the application of which includes: estimating a current noise spectrum of the received audio signal after the application of the first noise cancellation algorithm, wherein the current noise spectrum is estimated using the audio signal received by the second acoustic sensor; determining a punished noise spectrum using the time-average level difference between the audio signal received by the first acoustic sensor and the current noise spectrum; determining a final noise estimate by subtracting the punished noise spectrum from the current noise spectrum; and applying a second noise reduction algorithm to the audio signal received by the first acoustic sensor using the final noise estimate; and outputting a single audio stream with reduced background noise.

The method may further include the step of applying an acoustic echo canceller module to the audio signal to remove echo due to speaker-to-microphone feedback paths. It may also include correcting for a mismatch between the first acoustic sensor and the second acoustic sensor. Further, determining a punished noise spectrum using the time-average level difference between the audio signal received by the first acoustic sensor and the current noise spectrum, may include determining a punishment factor curve.

The systems and methods taught herein provide efficient and effective solutions for improving the noise reduction performance of audio devices using multiple microphones for audio capture.

Additional objects, advantages and novel features of the present subject matter will be set forth in the following description and will be apparent to those having ordinary skill in the art in light of the disclosure provided herein. The objects and advantages of the invention may be realized through the disclosed embodiments, including those particularly identified in the appended claims.

### BRIEF DESCRIPTION OF THE DRAWINGS

The drawings depict one or more implementations of the present subject matter by way of example, not by way of limitation. In the figures, the reference numbers refer to the same or similar elements across the various drawings.

FIG. 1 is a schematic representation of a handheld device that applies noise suppression algorithms to audio content captured from a pair of microphones.

FIG. 2 is a flow chart illustrating a method of applying noise suppression algorithms to audio content captured from a pair of microphones.

FIG. 3 is a block diagram of an example of a noise suppression algorithm.

FIG. 4 is an example of a noise suppression algorithm that applies varying noise suppression based on applying varying degrees of punishment to the level of the noise reference spectrum depending on the time-average level difference between the primary microphone spectrum versus the noise reference.

### DETAILED DESCRIPTION OF THE INVENTION

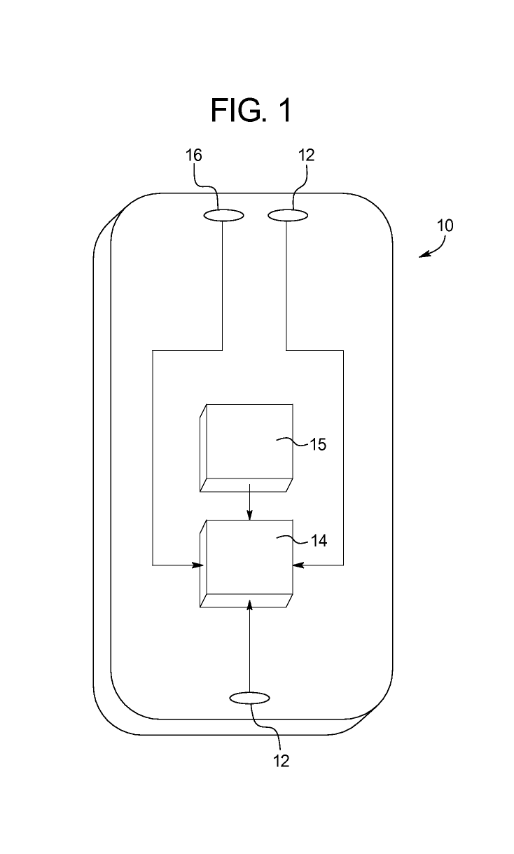

FIG. 1 illustrates a preferred embodiment of an audio device 10 according to the present invention. As shown in FIG. 1, the device 10 includes two acoustic sensors 12, an audio processor 14, memory 15 coupled to the audio processor 14, and a speaker 16. In the example shown in FIG. 1, the device 10 is a smartphone and the acoustic sensors 12 are microphones. However, it is understood that the present invention is applicable to numerous types of audio devices 10, including smartphones, tablets, Bluetooth headsets, hand free car kits, etc., and that other types of acoustic sensors 12 may be implemented. It is further contemplated that various embodiments of the device 10 may incorporate a greater number of acoustic sensors 12.

The audio content captured by the acoustic sensors 12 is provided to the audio processor 14. The audio processor 14 applies noise suppression algorithms to audio content, as described further herein. The audio processor 14 may be any type of audio processor, including the sound card and/or audio processing units in typical handheld devices 10. An example of an appropriate audio processor 14 is a general purpose CPU such as those typically found in handheld devices, smartphones, etc. Alternatively, the audio processor 14 may be a dedicated audio processing device. In a preferred embodiment, the program instructions executed by the audio processor 14 are stored in memory 15 associated with the audio processor 14. While it is understood that the memory 15 is typically housed within the device 10, there may be instances in which the program instructions are provided by memory 15 that is physically remote from the audio processor 14. Similarly, it is contemplated that there may be instances in which the audio processor 14 may be provided remotely from the audio device 10.

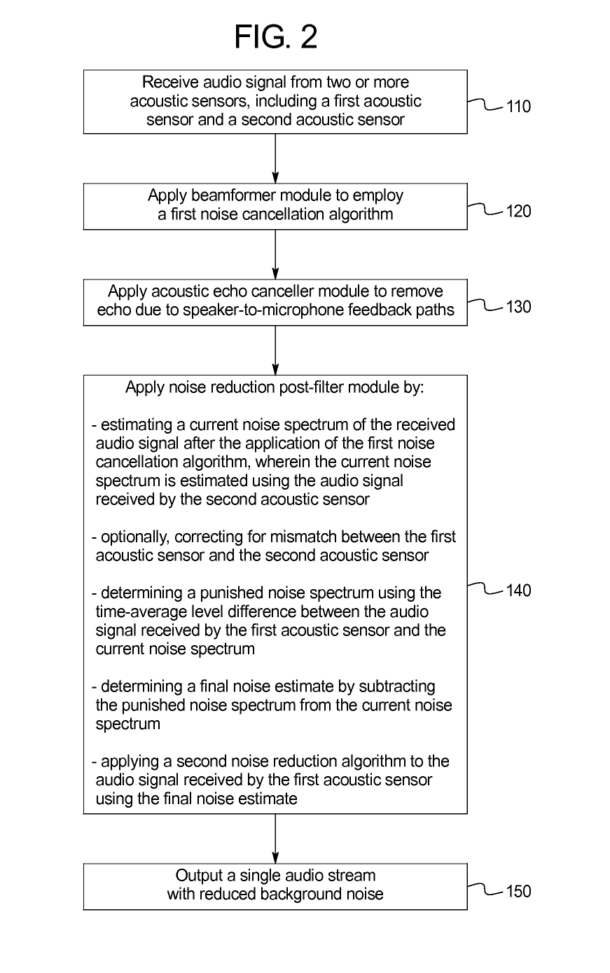

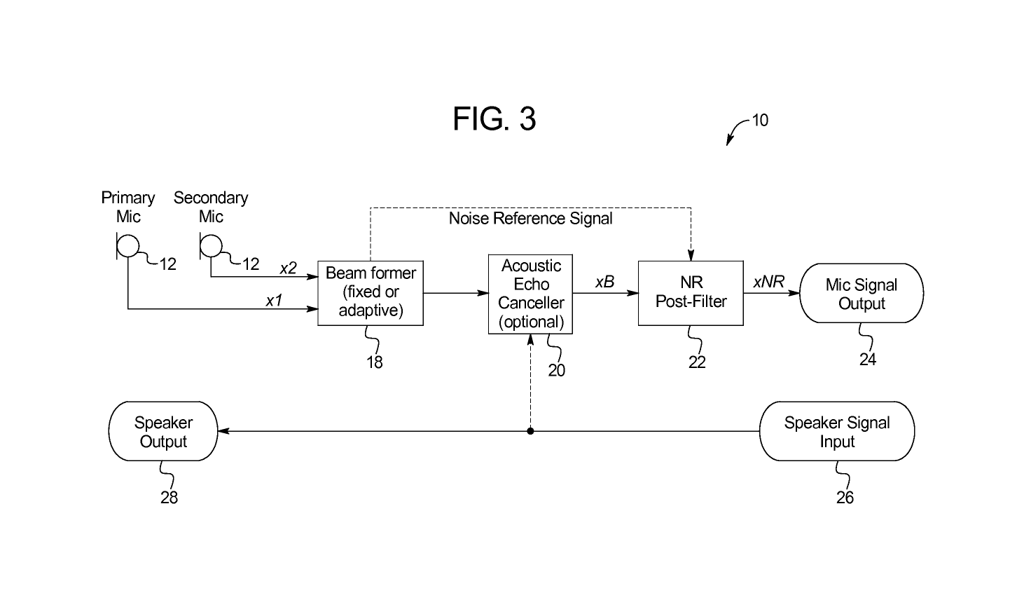

Turning now to FIG. 2, a process flow for providing improved noise reduction using direction-of-arrival information 100 is provided (referred to herein as process 100). The process 100 may be implemented, for example, using the audio device 10 shown in FIG. 1. However, it is understood that the process 100 may be implemented on any number of types of audio devices 10. Further illustrating the process, FIG. 3 is a schematic block diagram of an example of a noise suppression algorithm.

As shown in FIGS. 2 and 3, the process 100 includes a first step 110 of receiving an audio signal from the two or more acoustic sensors 12. This is the audio signal that is acted on by the audio processor 14 to reduce the noise present in the signal, as described herein. For example, when the audio device 10 is a smartphone, the goal may be to capture an audio signal with a strong signal the user's voice, while suppressing background noises. However, those skilled in the art will appreciate numerous variations in use and context in which the process 100 may be implemented to improve audio signals.

As shown in FIGS. 2 and 3, a second step 120, includes applying a beamformer module 18 to employ a first noise cancelling algorithm to the audio signal. A fixed or an adaptive beamformer 18 may be implemented. For example, the fixed beamformer 18 may be a delay-sum, filter-sum, or other fixed beamformer 18. The adaptive beamformer 18 may be, for example, a generalized sidelobe canceller or other adaptive beamformer 18.

In FIGS. 2 and 3, an optional third step 130 is shown wherein an acoustic echo canceller module 20 is applied to remove echo due to speaker-to-microphone feedback paths. The use of an acoustic echo canceller 20 may be advantageous in instances in which the audio device 10 is used for telephony communication, for example in speakerphone, VOIP or video-phone application. In these cases, a multi-microphone beamformer 18 is combined with an acoustic echo canceller 20 to remove speaker-to-microphone feedback. The acoustic echo canceller 20 is typically implemented after the beamformer 18 to save on processor and memory allocation (if placed before the beamformer 18, a separate acoustic echo canceller 20 is typically implemented for each microphone channel rather than on the mono signal output from the beamformer 18). As shown in FIG. 3, the acoustic echo canceller 20 receives as input the speaker signal input 26 and the speaker output 28.

As shown in FIGS. 2 and 3, a fourth step 140 of applying a noise reduction post-filter module 22 is shown. The noise reduction post-filter module 22 is used to augment the beamformer 18 and provide additional noise suppression. The function of the noise reduction post-filter module 22 is described in further detail below.

The main steps of the noise reduction post-filter module 22 can be labeled as: (1) mono noise estimate; (2) mismatch correction; (3) noise reference signal analysis; (4) final enhanced noise estimate; and (5) noise reduction using enhanced noise estimate. Summaries of each of these functions follow. Descriptions of each of these functions follow.

The mono noise estimate involves estimating the current noise spectrum of the mono input provided to the noise reduction post-filter module 22 (i.e., the mono output after the beamformer module 18). Common techniques used for mono channel noise estimation, such as frequency-domain minimum statistics or other similar algorithms, that can accurately track stationary, or slowly-changing background noise, can be employed in this step. In the primary example, the mono noise estimate is based on the audio signal received from the secondary audio signal received through the microphone 12 furthest from the user's mouth.

The noise reduction post-filter module 22 may optionally include a mismatch correction process. The mismatch correction process can improve noise reduction performance in situations in which a microphone mismatch is expected. Through the mismatch correction process, the secondary microphone signal (i.e., the noise reference signal) is corrected for anytime there is an invariant or slowly changing amplitude mismatch in the system 10. Such a mismatch between microphone signals can arise due to manufacturing tolerances and/or an acoustical mismatch due to the device's form factor or room acoustics. The goal of this process is to correct the noise reference signal so that the time-averaged noise power is equal between the primary microphone signal and the noise reference signal. This correction can be done in the time-domain or frequency-domain. The frequency-domain has the advantage that the amplitude correction can be performed on a frequency-dependent basis as shown in the equation below:

R(f,t)=X₂(f,t)β(f)

where X₂ is the secondary microphone spectrum (i.e., the noise reference spectrum) at time t. β is the frequency dependent amplitude mismatch correction, and R is the corrected noise reference to be used in the noise reference signal analysis.

It may be desirable to restrict the adaptation of the mismatch correction factor β(f) to be within a given range β_{MIN}≦β≦β_{MAX} to improve system stability. In addition, for implementations involving both the mismatch correction β(f), as well as well as acoustic echo canceller 20, additional robustness can be achieved by disabling the adaptation β(f) when the speaker channel is active (i.e., when the far-end signal is active).

The noise reduction post-filter module 22 may adapt the mismatch correction factor β(f) in real-time. As mentioned above, the algorithm assumes that all noise sources are located in the far-field of the microphone array. Therefore, the goal of the mismatch correction is to ensure that the noise level is approximately equal between the primary microphone 12 X₁(f) and noise reference microphone 12 X₂(f) when far-field noise sources are dominant.

The mismatch correction factor β(f) is adapted based on the time-averaged amplitude ratio |X1(f)|/|X2(f)| as follows:

$$β ( f ) = ( 1 - τ ) β ( f ) + τ \frac{\vert {X}_{1} ( f ) \vert}{\vert {X}_{2} ( f ) \vert}$$

where τ represents the adaptation time constant. It is further contemplated that adaptation may also be done using a power ratio or dB difference. The adaptation of β(f) is controlled via a Voice Activity Detector (VAD) and is only performed when the target voice is inactive (i.e., during noise-only periods). Common VAD algorithms include signal-to-noise-ratio-based techniques and/or pitch detection techniques to determine when voice activity is present.

The noise reference signal analysis process then uses the corrected noise reference signal from the optional mismatch correction module to improve the noise estimate from the mono noise estimate module so that the system 10 can track both stationary and non-stationary noises. As described above, there are situations in which the noise reference spectrum R(f) will be corrupted by leakage of the target voice into the noise reference signal. In order to obtain a final, robust noise estimate for the system 10, the noise reference spectrum must account for this leakage.

The voice leakage problem may be mitigated by “punishing” the level of the noise reference spectrum R(f) depending on the time-average level difference between the primary microphone spectrum X₁(f) versus the noise reference as follows:

$${R}_{P} ( f , t ) = R ( f , t ) λ ( f )$$

$$λ \leq 1$$

$$λ ( f ) = ℱ ( \frac{〈 {X}_{1} ( f ) 〉}{〈 R ( f ) 〉} )$$

R_{P} is the noise reference spectrum after being adjusted by the punishment factor 30, λ.

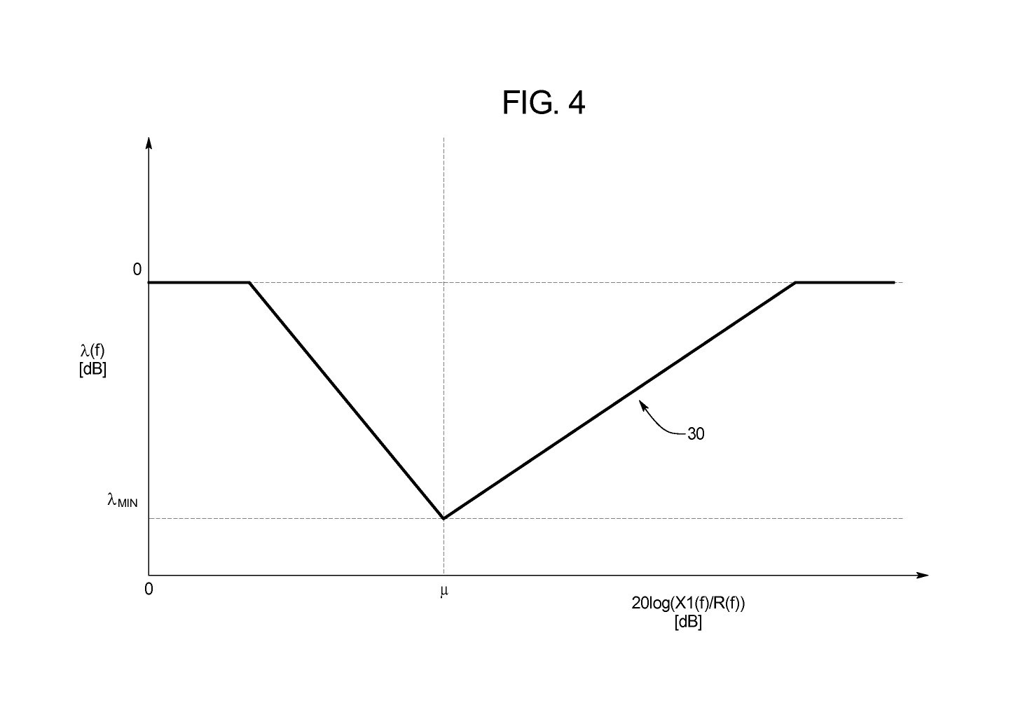

In the example shown in FIG. 4, the punishment factor 30 is expressed as a simple piece-wise linear function for λ, but other alternatives such as quadratic or cubic functions are also appropriate. The behavior of the punishment factor 30 can explained as follows below.

For a given frequency band, if the level difference between primary microphone level X₁(f) and the noise reference R(f) approaches 0 dB (i.e., the primary and secondary microphone inputs have equal power), it is assumed that a far-field noise source is dominant. Therefore, no voice leakage is present on R(f) and the punishment factor 30 is λ=0 dB (no noise punishment).

If the ratio X1/(f/R(f) approaches an intermediate value μ corresponding to the expected voice level difference between the primary and secondary microphones, then there is a high probability of the target voice—and thus voice leakage on the secondary microphone—being present. In this case, the punishment factor 30 approaches a minimum value (i.e., noise reference R(f) is maximally punished). The expected voice level difference μ can be easily approximated for a given device through either empirical measurement using a Head-and-Torso Simulator (HATS), or using information about the microphone array geometry such as:

$$μ \approx 20 {log}_{10} ( \frac{m + d}{m} ) [ dB ]$$

where d is the microphone-to-microphone distance (for dual microphone examples) and m is the expected distance between the primary microphone and the user's mouth.

If the ratio X1(f)/R(f) rises significantly higher above μ (e.g., due to acoustic diffraction effects or if the user moves his or her mouth closer than expected to the primary microphone), the voice leakage in R(f) becomes less of an issue and so the punishment factor 30 rises towards 0 dB again. In other words, if the voice level difference between X1(f) and R(f) is very high, then a small amount of leakage will not cause the noise reduction algorithm to significantly suppress or distort the target voice.

It should be noted that the exact shape of the curve expressing the punishment factor 30 can be tuned to obtain the desired amount of aggressiveness of the noise reduction post-filter 22 for a given application.

Although the primary example provided herein includes a noise punishment factor 30λ(f)≦0 dB, it may be desirable to have λ>0 in some situations where more aggressive noise reduction is wanted. Doing so acts as an alternative to the so-called “over-subtraction” factor used in Wiener Filtering to improve the stability of noise reduction algorithms and reduce musical noise artifacts, etc.

Additionally, it may be desirable in some situations to use different punishment factors 30λ(f) for different frequency regions to allow the multi-microphone noise reduction post-filter 22 to be more or less aggressive at different frequencies.

The final enhanced noise estimate is obtained by taking the maximum of the punished noise reference spectrum R_{P}(f) from the noise reference signal analysis against the mono noise estimate on a subband-by-subband basis. As a result, the final noise estimate is able to track both stationary noise sources as well as non-stationary noise sources that the original mono noise estimator may have missed.

The noise reduction using the enhanced noise estimate process uses the spectral noise estimate from the final enhanced noise estimate process described above to perform noise reduction on the audio signal. Common noise reduction techniques such as Wiener filtering or Spectral Subtraction can be used in this process. However, because the final enhanced noise estimate has been enhanced to include non-stationary noise sources, the amount of achievable noise reduction is superior to traditional mono noise reduction algorithms. The noise reduction results are further improved (as compared to traditional noise reference signal techniques) by reducing the amount voice leakage in the noise reference signal and by automatically adjusting for microphone mismatch, as described above.

Turning back to FIG. 2, a fifth step 150 completes the process 100 by outputting a single audio stream with reduced background noise compared to the input audio signal received by the acoustic sensors 12.

It should be noted that various changes and modifications to the presently preferred embodiments described herein will be apparent to those skilled in the art. Such changes and modification may be made without departing from the spirit and scope of the present invention and without diminishing its advantages.

I claim:

1. An audio device comprising:
an audio processor and memory coupled to the audio processor, wherein the memory stores program instructions executable by the audio processor, wherein, in response to executing the program instructions, the audio processor is configured to:
receive an audio signal from two or more acoustic sensors, including a first acoustic sensor and a second acoustic sensor;
apply a beamformer module to employ a first noise cancellation algorithm;
apply a noise reduction post-filter module to the audio signal, the application of which includes:
estimating a current noise spectrum of the received audio signal after the application of the first noise cancellation algorithm, wherein the current noise spectrum is estimated using the audio signal received by the second acoustic sensor;
determining a punished noise spectrum using the time-average level difference between the audio signal received by the first acoustic sensor and the current noise spectrum;
determining a final noise estimate by subtracting the punished noise spectrum from the current noise spectrum; and
applying a second noise reduction algorithm to the audio signal received by the first acoustic sensor using the final noise estimate; and
output a single audio stream with reduced background noise.

2. The device of claim 1 wherein, in response to executing the program instructions, the audio processor is configured to correct for a mismatch between the first acoustic sensor and the second acoustic sensor.

3. The device of claim 2 wherein the mismatch correction is based on a comparison of the time-averaged amplitude ratio of the audio signals received from the first acoustic sensor and the second acoustic sensor when voice activity is not present.

4. The device of claim 3 wherein the mismatch correction is based on a correction factor that is restricted within a predefined range.

5. The device of claim 4 wherein the adaptation of the correction factor occurs in real-time.

6. The device of claim 1 wherein, in response to executing the program instructions, the audio processor is further configured to apply an acoustic echo canceller module to the audio signal to remove echo due to speaker-to-microphone feedback paths.

7. The device of claim 1 wherein the beamformer module employs a first noise cancellation algorithm that is a fixed noise cancellation algorithm.

8. The device of claim 1 wherein the beamformer module employs a first noise cancellation algorithm that is an adaptive noise cancellation algorithm.

9. The device of claim 1 wherein determining a punished noise spectrum using the time-average level difference between the audio signal received by the first acoustic sensor and the current noise spectrum, includes determining a punishment factor curve.

10. The device of claim 9 wherein the punishment factor curve is expressed as a linear function.

11. The device of claim 9 wherein the punishment factor curve is expressed as a non-linear function.

12. The device of claim 9 wherein the punishment factor curve includes separate punishments factors within different frequency regions.

13. The device of claim 1 wherein the second noise reduction algorithm is a Wiener filter.

14. The device of claim 1 wherein the second noise reduction algorithm is a spectral subtraction filter.

15. A computer implemented method of reducing noise in an audio signal captured in an audio device comprising the steps of:
receiving an audio signal from two or more acoustic sensors, including a first acoustic sensor and a second acoustic sensor;
applying a beamformer module to employ a first noise cancellation algorithm;
applying a noise reduction post-filter module to the audio signal, the application of which includes:
estimating a current noise spectrum of the received audio signal after the application of the first noise cancellation algorithm, wherein the current noise spectrum is estimated using the audio signal received by the second acoustic sensor;
determining a punished noise spectrum using the time-average level difference between the audio signal received by the first acoustic sensor and the current noise spectrum;
determining a final noise estimate by subtracting the punished noise spectrum from the current noise spectrum; and
applying a second noise reduction algorithm to the audio signal received by the first acoustic sensor using the final noise estimate; and
outputting a single audio stream with reduced background noise.

16. The method of claim 15 further comprising the step of applying an acoustic echo canceller module to the audio signal to remove echo due to speaker-to-microphone feedback paths.

17. The method of claim 15 further comprising the step of correcting for a mismatch between the first acoustic sensor and the second acoustic sensor.

18. The method of claim 15 wherein determining a punished noise spectrum using the time-average level difference between the audio signal received by the first acoustic sensor and the current noise spectrum, includes determining a punishment factor curve.
